(19) United States
(12) Patent Application Publication
(10) Pub. No.: US 2009/0321279 A1
(43) Pub. Date: Dec. 31, 2009

(54) DIAGNOSIS OF A CRACKED MULTI-CHAMBER SOLID-ELECTROLYTE GAS SENSOR

(76) Inventors: Charlotte Holmen, Torsland (SE); Henrik Svenningstorp, Goteborg (SE)

Correspondence Address: WRB-IP LLP, 1217 KING STREET, ALEXANDRIA, VA, 22314, US

(21) Appl. No.: 12/307,594

(22) PCT Filed: Jul. 6, 2006
(86) PCT No.: PCT/SE2006/000850

§ 371 Date: Aug. 18, 2009

(51) Int. Cl. G01N 27/417

(52) U.S. Cl. 205/781; 204/401

(57) ABSTRACT

A diagnosis method and a gas sensor that is adapted to perform the diagnosis method are described for detecting a damage of a gas sensor causing a malfunction, particularly a crack, wherein the gas sensor has at least two chambers with one chamber comprising a reference gas. The method includes pumping out gas of one of the chambers, measuring a value of a variable being proportional to the concentration of the gas as a function of time, comparing the measured variable value and/or the measured time to a predetermined threshold, detecting a damage of the sensor if the measured variable value and/or the measured time is outside the interval of normal mode of operation defined by the corresponding predetermined threshold.

### BACKGROUND AND SUMMARY

The present invention relates to a method for detecting a damage of a gas sensor causing a malfunction, particularly a crack of the gas sensor, and a gas sensor being adapted to perform the detection method, wherein said gas sensor comprises at least two chambers with one chamber comprising a reference gas.

Gas sensors of the above identified kind are used, for example, for measuring a NOx-content in an exhaust gas discharged from a vehicle. Upcoming legislation demands for light and heavy-duty vehicles will require both use of and diagnosis of complex after-treatment systems. These after-treatment systems comprise a plurality of components such as gas sensors for sensing the NOx content of an exhaust air of the combustion engine. For robust diagnosis and for the ability to identify malfunctioning components, methods for checking the function of an individual component will be very useful.

A typical gas sensor, particularly a NOx-sensor, uses the concentration of oxygen as reference, since the NOx concentration can be determined by reducing 2NO to N2+2O⁻. Such a gas sensor comprises at least two chambers, wherein one chamber is in connection with an exhaust pipe of a vehicle for introducing the exhaust gas and having a well defined constant oxygen concentration and a second chamber comprising a reference gas, for example atmospheric air, also having a predetermined concentration of oxygen. In the first chamber, a detecting means is arranged to detect oxygen and also to modify the gas so that a well-defined gas concentration is obtained. As a result, the oxygen concentration in the second chamber is decreased to a well-defined concentration. By means of a pumping means the concentration of oxygen in the second chamber is kept constant. The necessary pumping current in turn can be used as a measure for the NOx concentration in the exhaust gas. The oxygen that origins from reduced NO in the second chamber is proportional to the NOx concentration in the exhaust gas. An exemplary NOx sensor of the above described kind is disclosed in patent application EP 1 464 954 A2.

The measurement method of the above described gas sensor relies on the predefined oxygen concentration and its increase is caused by the reduction reaction. Thus, a leakage of oxygen into the first and/or second chamber, due to a damage of the sensor, particularly a crack, needs to be detected.

That means, for example, in the case of an oxygen sensor, the gas concentration in the first chamber is modified to be at a constant oxygen concentration. The pumping current of oxygen to or from the first chamber correlates with the oxygen concentration in the exhaust gas. A crack in the first chamber, which results in leakage of oxygen from the air side or exhaust side, or in the reference chamber, which results in leakage of oxygen from the exhaust side, leads to an off set error in the sensor signal.

Therefore, it has been suggested to run a software program which is supposed to detect a malfunctioning of the sensor by running suitable test programs for the electronic of the sensor. An example for a so called OBD=On Board Diagnosis is disclosed in the U.S. Pat. No. 6,588,251 B1.

Disadvantageouŝ, the test programs are only able to detect damages or interruptions in the electronic parts of the sensor. A damage of the “hard ware”, particularly a damage of one of the chambers, can not be detected.

Further, U.S. Pat. No. 6,367,320 discloses a monitoring system for an exhaust gas treatment system wherein the temperatures at the input side and output side of the components of the system are monitored. If the temperature at the input side and output side of such a component is constantly very high, the statistic probability, that said component is damaged, is also very high.

Disadvantageously, a definite determination whether a component of the exhaust gas treatment system is in fact damaged, is not possible.

It is desirable to provide a detection method and a gas sensor comprising corresponding detection means which allow for the detection of a damage in the hardware components of a gas sensor.

According to an aspect of the invention, the detecting method is based on the idea to detect damage in a gas sensor by determining a gas concentration in a chamber of the gas sensor as a function of time. Therefore, the gas of the chamber to be investigated is pumped out and the time required pumping out the chamber or the remaining gas concentration in the chamber is measured. The measured time and/or the remaining gas concentration are compared to a predetermined threshold value. In case the time required and/or the remaining gas concentration is outside the interval of normal mode of operation defined by the corresponding predetermined threshold (for instance by exceeding, by passing or by not reaching, as the case may be) the predetermined threshold value, damage is detected.

In a preferred embodiment of an aspect of the present invention the method is performed for each of the chambers being comprised by the gas sensor.

According to another preferred embodiment of an aspect of the invention the method is performed when the gas sensor starts operating.

An inventive gas sensor according to a preferred embodiment comprises at least two chambers, wherein one chamber comprises a reference gas, first pumping means for pumping out gas of one of the chambers and first measuring means for measuring the gas concentration as a function of time. Further, the gas sensor can also comprise comparison means for comparing the measured gas concentration with a predetermined value.

Preferably, the inventive gas sensor is a NOx-sensor which uses air as reference gas. Advantageously, the gas sensor can comprise a plurality of chambers each being adapted to sense a different gas, not only NOx. For sensing a plurality of gases, the gas sensor can also be provided with different materials within one chamber or within the plurality of chambers wherein the materials are selected to sense different gases.

### BRIEF DESCRIPTION OF THE DRAWINGS

The invention may be understood more clearly by reference to the following detailed description of the drawings. However, description and drawings are only illustrative of a preferred embodiment and are not intended that the present invention is limited thereto. It shows:

FIG. 1: a schematic view of the basic components of an embodiment of the inventive gas sensor; and

FIG. 2: a diagram of the gas sensor signal plotted against time of a plurality of gas sensors placed in ambient air environment and having different damaging states according to a preferred embodiment of the inventive detection method.

### DETAILED DESCRIPTION

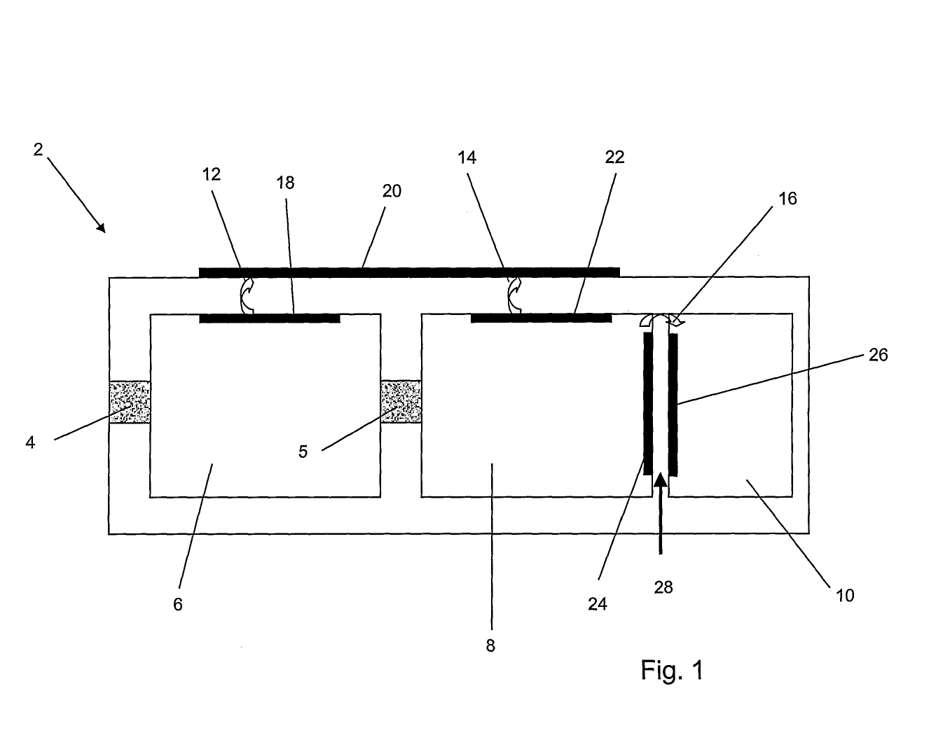

FIG. 1 shows a preferred embodiment of a gas sensor 2 for measuring a NOx concentration in an exhaust gas of a vehicle which is constructed by stacking, for example, six solid electrolyte layers each of which is composed of a ceramics having an oxygen ion-conductive solid electrolyte such as ZrO2.

The gas sensor 2 has a gas-introducing first hole 4, which is disposed at an end of the gas sensor 2, has a predetermined opening area, and is in connection with an exhaust pipe of a vehicle. A first chamber 6 is in connection with the gas—introducing hole 4, into which an exhaust gas as measurement gas is introduced,

Further, the gas sensor 2 has a second chamber 8 into which the measurement gas is introduced from the first chamber 6 through a second hole 5 connecting the first chamber 6 and the second chamber 8, and a reference chamber 10 into which a reference gas, for example, atmospheric air is introduced to serve as a reference for measuring NOx.

The gas sensor 2 also includes a first pumping means 12 which controls the partial pressure of oxygen contained in the measurement gas introduced into the first chamber 6 to be substantially constant, a second pumping means 14 which controls the partial pressure of oxygen introduced into the second chamber 8 to have a predetermined value, and a measuring pumping means 16 which reduces the NOx component contained in the measurement gas introduced from the second chamber 8, and pumps out oxygen produced by the reduction of NOx. The concentration of NOx in the measurement gas is determined from the value of the electric current used for driving the measuring pumping means 16 and detected by the measuring pumping means 16.

The first pumping means 12 comprises an inner pumping electrode 18 which has a porous cermet electrode or the like and is arranged in the first chamber 6, and an outer pumping electrode 20 having a porous cermet electrode or the like and being arranged outside the first chamber 6. A solid electrolyte layer can be interposed between both electrodes 18 and 20.

Between the inner pumping electrode 18 and the outer pumping electrode 20 a control voltage Vo is applied by a power source to drive a pumping current I0 in the positive or negative direction between the outer pumping electrode 20 and the inner pumping electrode 18. Accordingly, oxygen can be pumped out from or pumped into the first chamber 6 to/from the outside.

Since the oxygen concentration in the first chamber 6 depends on the combustion states of the vehicles engine—rich/lean combustion <-> low/high oxygen concentration—the gas sensor 2 comprises a feedback system (not shown) which controls the pumping in/out of oxygen by the first pumping means 12 in order to keep the oxygen concentration of the first chamber 6 at a defined level.

The control of the defined oxygen concentration in the first chamber 6 is necessary since the oxygen concentration of the second chamber 8 can be controlled by the oxygen content in the first chamber 6. It is further necessary to control the oxygen concentration so that the oxygen concentration in the second chamber is low enough not to give any significant contribution to the ion pumping from the inner electrode 24. The major part of the NO reacts on the inner electrode 24 and not on the electrode 22 in the second chamber. This can be achieved by using a material with low reducibility with respect to NO for electrode 22, for example Pt, and a material with high reducibility with respect to NO for electrode 24, for example Rh.

The second pumping means 14 also includes an inner pumping electrode 22 which is composed of, for example, a porous cermet electrode and is arranged in the second chamber 8. The outer pumping electrode 20 which is arranged outside the first chamber 6 serves also as outer electrode for the second pumping means 14. Corresponding to the first pumping means 12 a solid electrolyte layer can be interposed between both electrodes 20 and 22.

A second control voltage Vi can be applied between the outer pumping electrode 20 and the inner pumping electrode 22 of the second pumping means 14 by a power source. Accordingly, oxygen is pumped out from or pumped into the second chamber 8 to/from the outside.

The value of the partial oxygen concentration in the second chamber 8 is detected by a detecting means (not shown). The detected value is used as feedback parameter for controlling the pumping in/out process in order to keep the oxygen level of the second chamber 8 on a predetermined value which does not affect the NOx measurement (very low).

The control of the oxygen concentration in the second chamber 8, is necessary so that the NO concentration in the second chamber is not reduced by the inner pumping electrode 22 and to avoid oxygen from reacting at the inner most electrode 24. Therefore, it is also preferable to use a material having a weakened reducing ability or no reducing ability with respect to the NO component contained in the measurement gas.

The measuring pumping means 16 includes a detecting electrode 24 which is composed of, for example, a porous cermet electrode, a reference electrode 26 which is arranged in the reference chamber 10, and a solid electrolyte layer which is interposed between the electrodes 24 and 26.

The NOx in the measurement gas having been introduced into the detecting electrode 24 is reduced according to the reaction of 2NO->N2+20′ at the detecting electrode 24.

For that purpose, the detecting electrode 24 is composed of a porous cermet which comprises an alloy of Rh and Pt as metals capable of reducing NOx, and zirconia as ceramics. Accordingly, the detecting electrode 24 functions as a NOx—reducing catalyst for reducing NOx existing in the second chamber 8. Further, when a constant voltage V2 is applied by a power source between the detecting electrode 24 and the reference electrode 26, the oxygen contained in the second chamber 8 can be pumped out to the reference chamber 10. The pumping current I2, which flows in accordance with the pumping action of the measuring pumping means 16, can be detected and has a value which is proportional to the oxygen concentration in the second chamber 8, i.e., the sum of the oxygen concentration in the second chamber 8 and the oxygen concentration produced by the reduction of NOx effected by the detecting electrode 24. Therefore, the pumping current I2 is proportional to the concentration of NOx.

Since the determination of the NOx concentration depends on the predefined oxygen concentration in the second chamber, it is clear that a damage of the second chamber causing a leaking in of oxygen like a crack, results in a deterioration of the NOx measurement or a complete failure and therefore in a malfunctioning of the whole gas sensor 2. Therefore, even a small crack in the second chamber can have a significant deteriorating effect on the measurement result.

Consequently, even small cracks need to be detected, reliably. According to the invention, a measure for a potential damage of the second chamber is the time required pumping out oxygen of, for example, the second chamber, since, in case there is a crack, oxygen is leaking into the chamber at the same time as oxygen is being pumped out. Consequently, the time required pumping out the chamber increases and/or the concentration of oxygen still available in the chamber after a predetermined time is increased in comparison with the corresponding values of an intact gas sensor.

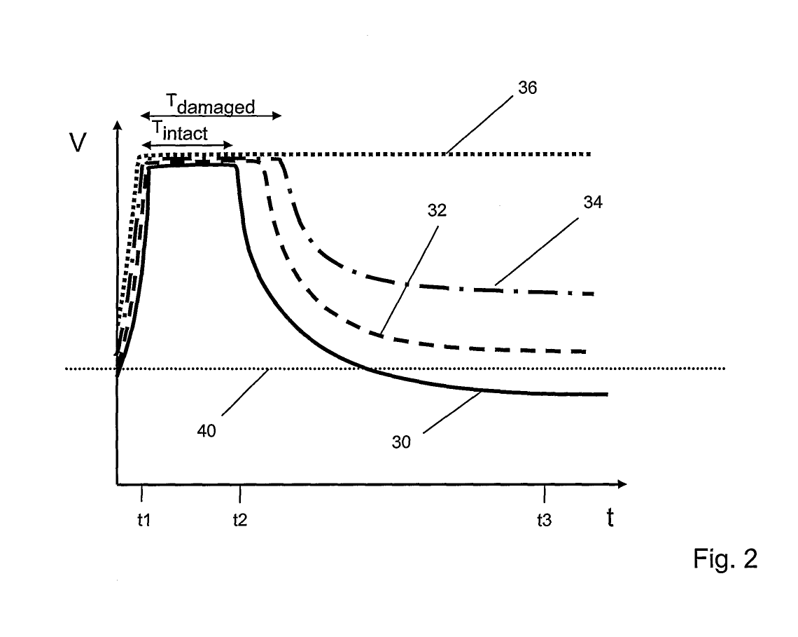

This behaviour is shown in FIG. 2, which shows a diagram of NOx gas sensor output signal (V) of a plurality of NOx gas sensors placed in an ambient air environment and having different cracking states as a function of time. The sensor output signal (V) is plotted on the y-axis wherein time t is plotted on the x-axis. The sensor output signal (V) is proportional to the NOx concentration, as explained above.

Two two-side arrows indicate two exemplary time periods Tintact, Tdamaged required for pumping out oxygen before a decrease in oxygen concentration is detected. The decrease in oxygen concentration results in a corresponding decrease in the sensor output signal (V). As can be seen in FIG. 2, the time periods Tintact and Tdamaged differ, whereby Tjntact-is equal to the time difference between time t2 and t1. At time t1 the sensor output signal (V) has reached—after a certain ramp-up phase—its maximum value, and at time t2 the sensor output signal (V) decreases again starting from said maximum value. Tdamaged is the corresponding time difference between two similar events (i.e. the time between the event when the sensor output signal reaches after the ramp-up phase its maximum and the event when it decreases again starting from said maximum). Time period Tintact is measured with an intact sensor, wherein time period Tdamaged is measured when oxygen is pumped out of a damaged chamber. As indicated by the curves in the diagram, the time period T can also be infinite, which corresponds to the case that the sensor is completely broken (see curve 36).

For the determination whether the sensor is damaged or not it is sufficient to compare the measured time period Tmeasured with a predetermined threshold, preferably the time TWact. In case the measured time Tmeasured exceeds the Tintact, a user/driver can be informed that the sensor is damaged.

Another possibility to determine, whether the sensor is damaged, is to compare the sensor output signal (V) after time Tintact with a predetermined value. In case the sensor is intact, a decrease in the signal is expected. Exceeds the sensor output signal value the predetermined value, the sensor is damaged.

It is also possible to compare the signal value later on, for example at time t3. In case the measured sensor output signal exceeds the threshold indicated by line 40, a damage is detected.

In FIG. 2, curve 30, indicated by a full line, shows the behaviour of an intact gas sensor. At time ti the pumping out process is started. During the time that the sensor pumps out oxygen from the chamber, the sensor signal is at its maximum value. After a time period the NOx-sensor signal decreases and reaches the value corresponding to the present NOx concentration. FIG. 2 exemplifies a measurement in air, i.e. without detectable concentration of NOx.

Curve 32 indicates the behaviour of a slightly damaged gas sensor. As can be seen, the time Tmeasured required to reach the point of a measurable sensor signal decrease is prolonged. Additionally, the sensor signal will not indicate the same value as with an intact sensor. This behaviour is even intensified if the damage of the gas sensor is more severe, as is shown by curve 34 indicating a cracked gas sensor. In case the sensor is severely damaged, as indicated by curve 36, a decrease of the sensor signal is not detectable any more but shows its constant maximum value.

The gas sensor 2 can also include a heater which generates heat in order to enhance the conductivity for oxygen ions. A ceramic layer composed of alumina or the like can cover upper and lower-surfaces of the heater in order to obtain the electric insulation with respect to the gas sensor 2.

The invention is also not restricted to the use of a two chamber NOx gas sensor, but it is also applicable to other kinds of gas sensors. Particularly, the invention is applicable to gas sensors having a plurality of “second chambers” each measuring a different gas. Also, it is possible to measure different gases by use of various materials arranged in one “second chamber” wherein each material is sensitive for a different gas.

### REFERENCE LIST

2 gas sensor
4 first gas introducing hole
5 second gas introducing hole
6 first chamber
8 second chamber
10 reference chamber
12 first pumping means
14 second pumping means
16 measuring pumping means
18 inner electrode
20 outer electrode
22 inner electrode
24 detecting electrode
26 reference electrode
30 curve indicating the sensor output signal of an intact gas sensor
32 curve indicating the sensor output signal of a slightly damaged gas sensor
34 curve indicating the sensor output signal of a damaged gas sensor 36 curve indicating the sensor output signal of a severely damaged gas sensor
40 threshold

1. Diagnosis method for detecting a damage of a gas sensor, particularly a crack, the gas sensor having at least two chambers with one chamber comprising a reference gas, comprising:
pumping out gas of one of the chambers;
measuring a value of a variable being proportional to the concentration of the reference gas as a function of time;
comparing the measured variable value and/or the measured time to a predetermined threshold; and
detecting a damage of the sensor if the measured variable value and/or the measured time is outside the interval of normal mode of operation defined by the corresponding predetermined threshold.

2. The method according to claim 1, wherein a damage is detected if the measured variable value does not reach the predetermined threshold and/or the measured time exceeds the predetermined threshold.

3. The method according to claim 1, wherein the predetermined threshold is a predetermined time period (Tintact); and the time compared to the predetermined threshold is a time period (Tmeasured) after which a change in the measured variable value is detected.

4. The method according to claim 1, wherein the measured variable value is the gas sensor output signal which is compared to a predetermined value for the sensor output signal.

5. The method according to claim 4, wherein the comparison takes place after a predetermined time.

6. The method according to claim 1, wherein the method is performed when the gas sensor starts operating.

7. The method according to claim 1, wherein the method is performed for each chamber comprised in the gas sensor.

8. Gas sensor for sensing gases, particularly a gas sensor for a combustion engine, comprising
at least two chambers, wherein one chamber comprises a reference gas;
first pumping means for pumping out gas of one of the chambers; and
first measuring means for measuring a value of a variable being proportional to a gas concentration;
wherein
the first measuring means is adapted to measure the variable value as a function of time;
the gas sensor further comprises comparison means for comparing the measured variable value and/or the measured time to a predetermined threshold; and
the gas sensor further comprises determination means for determining that a damage is detected if the measured variable value and/or the measured time is outside the interval of normal mode of operation defined by the corresponding predetermined threshold.

9. The gas sensor according to claim 8, wherein the gas sensor further comprises determination means for determining that a damage is detected if the measured variable value falls below the predetermined threshold and/or the measured time exceeds the predetermined threshold.

10. The gas sensor according to claim 8, wherein the predetermined threshold is a predetermined time period (Tintact), and the time compared to the predetermined threshold is a time period (Tmeasured) after which a change in the measured variable value is detected.

11. The gas sensor according to claim 8, wherein the measured variable value is the gas sensor output signal which is compared to a predetermined value for the sensor output signal.

12. The gas sensor according to claim 11, wherein the comparison takes place after a predetermined time.

13. The gas sensor according to claim 8, wherein the gas is a gas composition comprising at least two gas components.

14. The gas sensor according to claim 8, wherein the gas sensor is a NOx-sensor with air or oxygen as reference gas.

15. The gas sensor according to claim 8, wherein the gas sensor is adapted to sense a plurality of different specific gas components.

16. The gas sensor according to claim 15, wherein the gas sensor comprises a plurality of chambers each chamber sensing a different specific gas.

17. The gas sensor according to claim 15, wherein the gas sensor comprises a plurality of different materials each being adapted to sense a different gas.

18. The gas sensor according to claim 17, wherein the plurality of different materials is provided at a plurality of different places within the chambers.

19. Vehicle having a gas sensor according to claim 8.
